(19) United States
(12) Patent Application Publication
(10) Pub. No.: US 2015/0153168 A1
(43) Pub. Date: Jun. 4, 2015

(54) Device for determining the position of a signal source

(71) Applicants: Hans Poisel, Nurnberg (DE); Olaf Ziemann, Nurnberg (DE); Alexander Bachmann, Nurnberg (DE); Michael Luber, Nurnberg (DE)

(72) Inventors: Hans Poisel, Nurnberg (DE); Olaf Ziemann, Nurnberg (DE); Alexander Bachmann, Nurnberg (DE); Michael Luber, Nurnberg (DE)

(21) Appl. No.: 14/446,571

(22) Filed: Jul. 30, 2014

(30) Foreign Application Priority Data
Jul. 31, 2013 (DE) 102013012761.0

(51) Int. Cl. G01B 21/16

(52) U.S. Cl. CPC G01B 21/16

(57) ABSTRACT

The invention relates to a device for determining the position of a signal source configured to emit signals modulated by a modulation frequency, comprising: a conductor arranged in such a way that it receives the modulated signals at various positions along the conductor and configured to conduct the modulated signal, respectively in opposite directions, to a first conductor end and to a second conductor end when a modulated signal is received; a detector configured to acquire the modulated signal at the first conductor end and at the second conductor end; and a determination apparatus configured to: determine a phase difference between the modulated signal acquired at the first conductor end and the modulated signal acquired at the second conductor end, and determine the position of the signal source in relation to the conductor on the basis of the phase difference.

The invention relates to a device for determining the position of a signal source and an instrument in which such a device is used.

In various applications, a person skilled in the art is presented with the problem of determining the position of a component moving along a circulating trajectory. By way of example, there are cases in which the position of a rotating sensor is to be determined in the case of a computed tomography scanner.

In this respect, the prior art has disclosed a multiplicity of solutions. One solution consists of the component moving on a circulating trajectory and therefore rotating (i.e. the rotating sensor) being provided with an encoded pattern (so-called encoding discs), which is scanned optically. A further solution consists of arranging Hall elements on the rotating component such that magnetic measurements for determining the position can be carried out using Hall sensors.

However, a problem with this technique consists of the fact that encoding discs or Hall elements are to be applied on a rotationally symmetric arrangement. The use of encoding discs is usually cost-intensive. Moreover, encoding discs need to be adjusted with much outlay during the assembly. Sometimes, both the application of the encoding discs and the application of the Hall elements may be complicated if individual solutions for the encoding discs and the Hall elements need to be found for reasons of space.

A further solution is described in, for example, DE 4421616 A. In this prior art, a fluorescing optical fibre is bent to form a ring-shaped loop. The fluorescing optical fibre itself is a conventional optical fibre which has been suitably doped using a fluorescing dye, e.g. rhodamine G, Nile blue or others.

If this fluorescing optical fibre is irradiated by light with a suitable wavelength, e.g. 650 nm, the dye contained in the optical fibre will absorb the radiation and re-emit light with a longer wavelength (Stokes shift). The emission takes place within the optical fibre and in all directions, and so part of the fluorescent light emitted thus is conducted along the optical fibre to the end thereof, and is able to be detected there.

In accordance with the aforementioned prior art, an optical signal is applied to such a fluorescing optical fibre from the side over the circumferential area thereof, said signal originating from a signal source, e.g. an LED or a laser diode, and being modulated in accordance with the RZ or the NRZ pulse modulation scheme. Expressed differently, a digital signal is transmitted by discrete pulses, wherein a light-ON state may represent a 1 and a light-OFF state may represent a 0, or vice versa.

In an analogy to an electric potentiometer, the position at which the light was coupled into the fluorescing optical fibre can be determined by virtue of the light power initially being measured at both ends of the optical fibre with the aid of fibre sensors and, subsequently, the ratio of the light power at the two ends of the optical fibre being calculated. Expressed differently, an amplitude of light signals acquired at both ends of the optical fibre is initially measured in each case with the aid of fibre sensors. Subsequently, the ratio of the measured amplitude is calculated.

However, a problem with this technique consists of the fact that measurements of the amplitude in such fibre sensors are strongly dependent on external parameters and can therefore lead very quickly to incorrect measurements.

The object of the invention therefore consists of providing a device for determining the position of a signal source which overcomes these disadvantages.

The object of the invention is achieved by a device in accordance with independent Claims 1 and 3 and by an instrument in accordance with independent Claim 11. The dependent claims relate to further advantageous embodiments of the invention.

In accordance with one aspect of the invention, a device for determining the position of a signal source configured to emit signals modulated by a modulation frequency is provided, comprising:

a conductor arranged in such a way that it receives the modulated signals at various positions along the conductor and configured to conduct the modulated signal, respectively in opposite directions, to a first conductor end and to a second conductor end when a modulated signal is received,

a detector configured to acquire the modulated signal at the first conductor end and at the second conductor end, and
a determination apparatus configured to:
determine a phase difference between the modulated signal acquired at the first conductor end and the modulated signal acquired at the second conductor end, and
determine the position of the signal source in relation to the conductor on the basis of the phase difference.

In accordance with a further aspect of the invention, a device is provided, wherein the determination apparatus is furthermore configured to:

determine a travel time of the modulated signal acquired at the first conductor end as a first travel time and a travel time of the modulated signal acquired at the second conductor end as a second travel time on the basis of the phase difference,

determine a ratio of the first travel time to the second travel time, and

determine the position of the signal source on the basis of the ratio of the first travel time to the second travel time.

In accordance with a further aspect of the invention, a device for determining the position of a signal source configured to emit a signal modulated by a modulation frequency, which can be coupled into a conductor at different positions and is conducted along the conductor in opposite directions, is provided, wherein the device is configured to:

determine a phase difference between a modulated signal acquired at a first end of a conductor and a modulated signal acquired at a second end of the conductor, and

determine the position of the signal source in relation to the conductor on the basis of the phase difference.

In accordance with a further aspect of the invention, a device is provided, wherein the device is furthermore configured to:

determine a travel time of the modulated signal acquired at the first conductor end as a first travel time and a travel time of the modulated signal acquired at the second conductor end as a second travel time on the basis of the phase difference,

determine a ratio of the first travel time to the second travel time, and

determine the position of the signal source on the basis of the ratio of the first travel time to the second travel time.

In accordance with a further aspect of the invention, a device is provided, wherein the signal source and the conductor are configured to be movable relative to one another.

In accordance with a further aspect of the invention, a device is provided, wherein the conductor is embodied in a ring shape.

In accordance with a further aspect of the invention, a device is provided, wherein the conductor is formed from at least one conductor section.

In accordance with a further aspect of the invention, a device is provided, wherein the signals emitted by the signal source are optical signals and the conductor is a fluorescing optical fibre.

In accordance with a further aspect of the invention, a device is provided, wherein the signals emitted by the signal source are electrical signals and the conductor is an electrically conductive conductor.

In accordance with a further aspect of the invention, a device is provided, wherein the signals emitted by the signal source are acoustic signals and the conductor is an acoustic conductor.

In accordance with a further aspect of the invention, an instrument for transmitting data between two parts rotating relative to one another about a common axis, comprising a device according to the invention is provided, wherein the signal source is arranged on one part and the conductor is arranged about the rotational axis on the other part.

In accordance with a further aspect of the invention, an instrument is provided, wherein the instrument is a computed tomography scanner.

In accordance with a further aspect of the invention, an instrument is provided, wherein the instrument is a radar instrument.

In the following text, the invention is described in detail on the basis of the attached figures and preferred embodiments.

In detail:

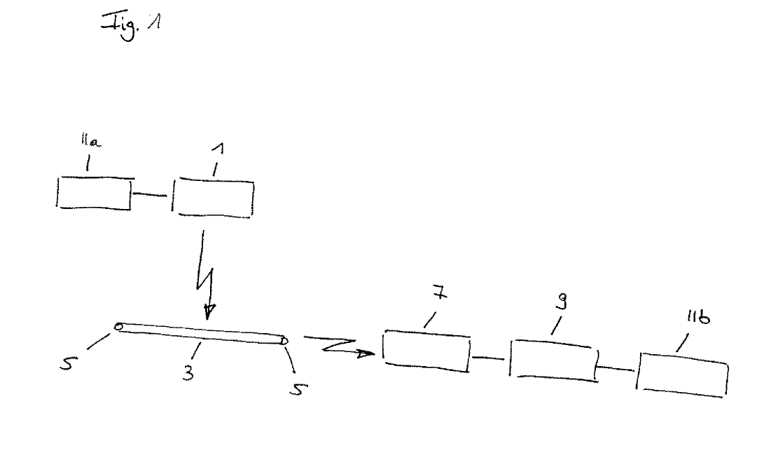

FIG. 1 shows a block diagram of the device according to the invention in accordance with a preferred embodiment;

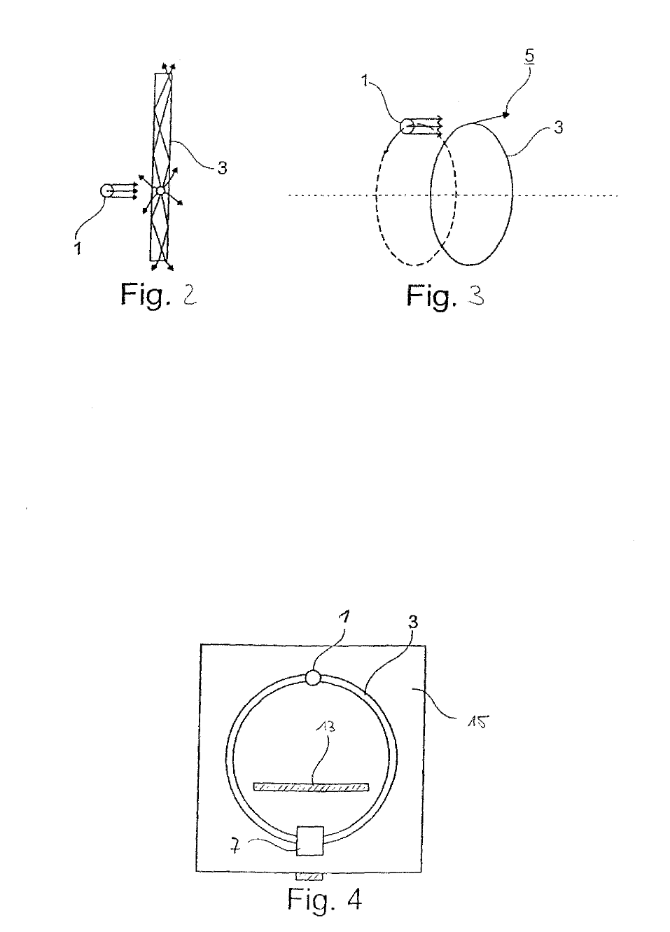

FIG. 2 shows the functional principle of the data transmission between a light source and a fluorescing optical fibre;

FIG. 3 shows a rough schematic design of a fibre optic rotating transmitter with a device for optical transmission of digital signals; and

FIG. 4 shows a cross section through a computed tomography device with the device according to the invention.

In accordance with a preferred embodiment of the invention, the device according to the invention for determining the position of a signal source 1 which emits signals modulated by a modulation frequency, which signals are coupled into a conductor 3 at different positions and conducted along the conductor 3 in opposite directions, comprises a determination apparatus 9.

In accordance with a further preferred embodiment of the invention, the device according to the invention for determining the position of a signal source 1 which emits signals modulated by a modulation frequency comprises a conductor 3, a detector 7 and a determination apparatus 9.

FIG. 1 shows a block diagram of the device according to the invention in accordance with a preferred embodiment.

In a data source (not shown here), a digital signal is fed to a predistorter 11a. In this predistorter 11a, the digital signal is converted into an analogue signal and applied to the signal source 1. The signal source 1 emits signals. The signals emitted by the signal source 1 have a level which is modulated by a modulation frequency on the basis of the digital data to be transmitted. Expressed differently, the signals are amplitude modulated. These amplitude modulated signals can be modulated either according to the known pulse amplitude modulation or according to the orthogonal frequency division multiplexing/discrete multi-tone modulation (OFDM/DMT). Other amplitude modulation techniques are likewise possible.

The modulated signals are received by the conductor 3 or coupled into the conductor 3 at different positions along the conductor 3. From the reception position, the modulated signal is conducted to the two ends 5 of the conductor 3 in respectively opposite directions.

The ends 5 of the conductor 3 are connected to the detector 7 which acquires the modulated signal as soon as it reaches the ends 5.

The determination apparatus 9 is arranged downstream of the detector 7. The determination apparatus 9 determines the phase difference between the modulated signal acquired at one end 5 of the conductor 3 and the modulated signal acquired at the other end 5 of the conductor 3. The determination apparatus 9 determines a travel time of the modulated signal acquired at one end 5 of the conductor 3 (“first travel time”) and a travel time of the modulated signal acquired at the other end 5 of the conductor 3 (“second travel time”) on the basis of the phase difference. The determination apparatus 9 determines a ratio of the first travel time to the second travel time. The determination apparatus 9 determines the position of the signal source 1 in relation to the conductor 3 on the basis of the ratio of the first travel time to the second travel time. This in turn means that the determination apparatus 9 determines the position of the signal source 1 in relation to the conductor 3 on the basis of the phase difference.

The signal source 1 and the conductor 3 are movable relative to one another. The signal source 1 and the conductor 3 can move coaxially with respect to one another. The conductor 3 can be embodied in a ring shape. Alternatively, the conductor 3 can be embodied in a spiral shape or have a linear extent. Furthermore, the conductor 3 is formed from at least one conductor section. The conductor 3 may also be formed from a plurality of conductor sections and therefore consists of a plurality of portions.

Expediently, an equalizer 11b is assigned to the detector 7 and the determination apparatus 9, which equalizer equalizes the received signal and converts it back into a digital signal.

In accordance with a further preferred embodiment of the invention, the signals emitted by the signal source 1 are optical signals and the conductor 3 is a fluorescing optical fibre. In this manner, there is contactless signal transmission between the signal source 1 and the conductor 3.

The functional principle of the fluorescing optical fibres is described in conjunction with FIG. 1. The light emitted by the signal source 1 is incident on the circumferential area of a fluorescing optical fibre 3. A dye contained in the fluorescing optical fibre 3 absorbs some of this light and, in turn, emits fluorescent light with a longer wavelength. In the case of a suitable selection of the dye and the excitation wavelength, it is possible to keep the partial overlap, which is usually present between the absorption spectrum and the emission spectrum, small such that there is only a small self-absorption.

The emission process occurs with a time delay typical for the dye (the so-called fluorescence lifetime) which usually lies in the range of a few nanoseconds, restricting the transmission bandwidth.

Depending on the design of the fluorescing optical fibre 3, especially on the numerical aperture, of the diameter and the like, some of the light generated within the fluorescing optical fibre 3 is captured in the latter and conducted by total internal reflection at the circumferential area to the two ends 5 of the fluorescing optical fibre 3. There, the light can be detected in a suitable manner. The light is detected by a detector 7, such as a photocell or the like. The proportion of the conducted radiation is described by the so-called piping efficiency PE.

PE=1−nₘ/nₖ,

where nₘ and nₖ are the refractive indices of the fibre cladding and the fibre core, respectively, of the fluorescing optical fibre 3.

As described in FIG. 3, it is particularly advantageous to bend the fluorescing optical fibre 3 into the form of a loop (i.e. into a ring shape) concentric with a rotational axis of a second component. On this second component, a laser diode or an LED is provided as an optical signal source 1, which is spaced apart from the rotational axis and configured in such a way that the light emitted thereby is incident on the fluorescing optical fibre 3 on the other component. If one of the two components now rotates about the common axis of rotation, reliable signal transmission between the two parts is nevertheless possible.

In accordance with this preferred embodiment, a mirror can be arranged on one of the two ends 5 of the fluorescing optical fibre 3, at which mirror the light conducted through the fibre is reflected such that it is conducted through the fibre to the other one of the two ends 5.

In accordance with a further preferred embodiment of the invention, the signals emitted by the signal source are electrical signals and the conductor 3 is an electrically conductive conductor. By way of example, the conductor 3 may consist of an electrically conductive metal. There is transmission of the signals from the signal source 1 to the conductor 3 by virtue of the signal source 1 e.g. contacting the conductor 3 by means of a sliding-action contact,

In accordance with a further preferred embodiment of the invention, the signals emitted by the signal source 1 are acoustic signals and the conductor 3 is an acoustic conductor. By way of example, the conductor 3 may be a pipe filled with a liquid, in which an acoustic wave excited by the signal source 1 propagates.

FIG. 4 shows the application of the invention in the context of a computed tomography scanner 15 as a system or an instrument in which the device according to the invention can be used in a particularly advantageous manner. In a computed tomography scanner, large amounts of data must regularly be transmitted between a rotating part and a stationary part within a short period of time. Transmission via the axis of rotation is not possible since the patient to be examined or the couch 13 for the patient is positioned there. Therefore, according to the invention, a loop-shaped (i.e. ring-shaped) conductor 3 is arranged on the stationary part of the computed tomography scanner, as shown in FIG. 4, the ends of which conductor are connected to a suitable detector circuit 7.

This loop is embodied concentrically with respect to the axis of rotation and at a distance from this axis of rotation in such a way that sufficient space is available for the patient. A signal source 1 is provided on the rotating part at a distance from the axis of rotation.

The image information recorded by the rotating part of the computed tomography scanner is converted into digital data, converted into an amplitude modulated signal at the signal source 1 using the pulse amplitude modulation method or the multiple frequency multiplexing method, and transmitted to the conductor 3.

The signal is conducted through the conductor 3 to the ends 5 thereof. A suitable detector 7 acquires the signal at the ends 5 of the conductor, which signal is then subjected to equalization and demodulation and an analogue/digital conversion. In this manner, the digital image data are reproduced on the receiver side. As a result of the high data transmission bandwidth provided by the instrument according to the invention, the image data may be transmitted with suitable error correction data such that a secure, reliable and fast data transmission is possible between the rotating and the stationary part.

Even though the invention was described on the basis of preferred embodiments, it is not restricted thereto. The invention can also advantageously be used in a radar antenna instead of in a computed tomography scanner.

1. Device for determining the position of a signal source (1) configured to emit signals modulated by a modulation frequency, comprising;
a conductor (3) arranged in such a way that it receives the modulated signals at various positions along the conductor and configured to conduct the modulated signal, respectively in opposite directions, to a first conductor end (5) and to a second conductor end (5) when a modulated signal is received,
a detector (7) configured to acquire the modulated signal at the first conductor end and at the second conductor end, and
a determination apparatus (9) configured to:
determine a phase difference between the modulated signal acquired at the first conductor end and the modulated signal acquired at the second conductor end, and
determine the position of the signal source in relation to the conductor on the basis of the phase difference.

2. Device according to claim 1, wherein the determination apparatus (9) is furthermore configured to:
determine a travel time of the modulated signal acquired at the first conductor end (5) as a first travel time and a travel time of the modulated signal acquired at the second conductor end (5) as a second travel time on the basis of the phase difference,
determine a ratio of the first travel time to the second travel time, and
determine the position of the signal source (1) on the basis of the ratio of the first travel time to the second travel time.

3. Device for determining the position of a signal source (1) configured to emit a signal modulated by a modulation frequency, which can be coupled into a conductor (3) at different positions and is conducted along the conductor (3) in opposite directions, wherein the device is configured to:
determine a phase difference between a modulated signal acquired at a first end (5) of a conductor (3) and a modulated signal acquired at a second end (5) of the conductor, and
determine the position of the signal source in relation to the conductor on the basis of the phase difference.

4. Device according to claim 3, wherein the device is furthermore configured to:
determine a travel time of the modulated signal acquired at the first conductor end (5) as a first travel time and a travel time of the modulated signal acquired at the second conductor end (5) as a second travel time on the basis of the phase difference,
determine a ratio of the first travel time to the second travel time, and
determine the position of the signal source (1) on the basis of the ratio of the first travel time to the second travel time.

5. Device according to claim 1, wherein the signal source (1) and the conductor (3) are configured to be movable relative to one another.

6. Device according to claim 1, wherein the conductor (3) is embodied in a ring shape.

7. Device according to claim 1, wherein the conductor (3) is formed from at least one conductor section.

8. Device according to claim 1, wherein the signals emitted by the signal source (1) are optical signals and the conductor (3) is a fluorescing optical fibre.

9. Device according to claim 1, wherein the signal emitted by the signal source (1) are electrical signals and the conductor (3) is an electrically conductive conductor.

10. Device according to claim 1, wherein the signals emitted by the signal source (1) are acoustic signals and the conductor (3) is an acoustic conductor.

11. Instrument (15) for transmitting data between two parts rotating relative to one another about a common axis, comprising a device according to one of claims 8 to 10, wherein the signal source (1) is arranged on one part and the conductor (3) is arranged about the rotational axis on the other part.

12. Instrument (15) according to claim 11, wherein the instrument is a computed tomography scanner.

13. Instrument (15) according to claim 11, wherein the instrument is a radar instrument.

14. Device according to claim 2, wherein the signal source (1) and the conductor (3) are configured to be movable relative to one another.

15. Device according to claim 2, wherein the conductor (3) is embodied in a ring shape.

16. Device according to claim 2, wherein the conductor (3) is formed from at least one conductor section.

17. Device according to claim 2, wherein the signs emitted by the signal source (1) are optical signals and the conductor (3) is a fluorescing optical fibre.

18. Device according to claim 2, wherein the signal emitted by the signal source (1) are electrical signals and the conductor (3) is an electrically conductive conductor.

19. Device according to claim 2, wherein the signals emitted by the signal source (1) are acoustic signals and the conductor (3) is an acoustic conductor.

20. Device according to claim 3, wherein the signal source (1) and the conductor (3) are configured to be movable relative to one another.
